(19) United States
(12) Patent Application Publication
(10) Pub. No.: US 2007/0224586 A1
(43) Pub. Date: Sep. 27, 2007

(54) METHOD AND SYSTEM FOR EVALUATING AND MATCHING EDUCATIONAL CONTENT TO A USER

(75) Inventors: Robert K. MASSIE, Somerville, MA (US); Christopher Brady MAGNUSSON, Somerville, MA (US)

Correspondence Address: WILMER CUTLER PICKERING HALE AND DORR LLP, 60 STATE STREET, BOSTON, MA, 02109, US

(73) Assignee: Robert K. Massie, Somerville, MA (US)

(21) Appl. No.: 11/685,942

(22) Filed: Mar. 14, 2007

Related U.S. Application Data
(60) Provisional application No. 60/785,444, filed on Mar. 24, 2006.
(60) Provisional application No. 60/820,428, filed on Jul. 26, 2006.

(51) Int. Cl. G09B 3/00

(52) U.S. Cl. 434/350

(57) ABSTRACT

A method of evaluating and matching educational content to a user is provided. The method includes identifying a plurality of online educational courses. The courses present educational content to a user over time. The method also includes creating a course profile for each course, each profile having one or more attributes of an associated course. The attributes characterize the educational content of the associated course. The method further includes receiving attributes of the user. The attributes describe preferences and characteristics of the user. In response to a request for a course from the user, the method calls for identifying one or more courses based on the attributes of the user and the attributes of the course, wherein the attributes of the user and the attributes of the one or more identified courses share a similar classification. The method presents to the user the identified one or more courses.

### CROSS-REFERENCE TO RELATED APPLICATIONS

This application claims the benefit of U.S. Provisional Application No. 60/785,444, entitled “E5F”, filed Mar. 24, 2006, and U.S. Provisional Application No. 60/820,428, entitled “A Many-To-Many Technology For Locating, Matching And Ranking Internet Courseware And Leaming Experiences”, filed Jul. 26, 2006, the contents of which are incorporated herein by reference.

### BACKGROUND OF THE INVENTION

1. Field of the Invention

This invention generally relates to providing on-line educational courses to a user.

2. Description of Related Art

Electronically-available educational content is growing in importance and popularity, with computer networks such as the Internet providing access to such content. Online encyclopedias (e.g., WIKIPEDIA and HIGHBEAM) are like their conventional counterparts in that they are a written compendium that contains information on a collection of subjects or on particular branches of knowledge. They typically treat each subject in varying degrees of depth and convey the most relevant information on each subject. For example, online encyclopedias often provide the history of a particular topic, names of individuals that are recognized as having contributed to the development of the topic, major subjects or themes of the topic, and collections of facts and answers to common questions related to the topic.

However, online encyclopedias differ from traditional encyclopedias in that traditional encyclopedias are typically written by highly trained writers whose work is reviewed and reworked by a group of central editors. In addition, those having specialized knowledge in a particular field may review the substance related to their field to ensure its accuracy. This is a very different model from having the collective judgment of hundreds or thousands of people work collaboratively on content that they judge to be accurate, as is found in many online encyclopedias.

Some universities and other organizations offer various online courses that model traditional teaching methods. These online courses typically contain a syllabus, which outlines the prerequisites of the course, the course objective, and resources the student will require to complete the course. The courses also typically provide a list of assignments (e.g., reading sections of a textbook or completing sets of practice problems), lecture notes that further coach the student on the subject matter of the course, and a system of evaluating the student's progress (e.g., quizzes or exams). These online courses may occasionally include streamed video.

Networked learning environments include many aspects of the online courses offered by universities, but they also add the ability for individuals to collaborate in the learning process. A networked learning environment allows students, teachers, and other members of the learning environment to interact during the learning process to share ideas, ask and answer questions, and assist one another. These environments also typically provide a common access portal to the content of the particular course.

### BRIEF SUMMARY OF THE INVENTION

The invention provides methods and systems for evaluating and matching educational content to a user.

In one aspect, the invention features a computer-implemented method including identifying a plurality of online educational courses. The online educational courses present educational content to a user over time. The method also includes creating a course profile for each online educational course. Each course profile has one or more attributes of an associated online education course. The attributes characterize the educational content of the associated online educational course. The method further includes receiving attributes of the user. The attributes describe preferences and characteristics of the user. In response to a request for an online educational course from the user, the method calls for identifying one or more online educational courses based on the attributes of the user and the attributes of the educational course, wherein the attributes of the user and the attributes of the one or more identified educational courses share a similar classification. The method presents to the user the identified one or more online educational courses.

In another aspect of the invention, the method also includes modifying one or more attributes of the course profiles associated with educational courses based on feedback about the education courses provided by the user. The modified course profiles can be associated with online educational courses the user has completed.

In a further aspect of the invention, the method also includes creating a user profile for the user. The user profile has one or more attributes of the associated user. The attributes describe preferences and characteristics of the user.

In yet a further aspect of the invention, the method also includes modifying one or more attributes of the user based on the user completing one of the online educational courses.

In an aspect of the invention, the method also includes modifying one or more attributes of the user based on progress of the user in one of the online educational courses.

In another aspect of the invention, the method also includes, for at least two online educational courses, receiving a quality measure of the educational content of the course supplied by an individual who has reviewed the course. In this aspect, the identifying one or more online educational courses is based on the quality measures of the at least two courses.

In a further aspect of the invention, the method also includes, for at least two online educational courses, receiving at least two quality measures and corresponding difficulty measures of the educational content of the course. The measures are supplied by individuals who have reviewed the courses. This aspect also includes receiving in the request for the online educational course from the user a desired course difficulty measure. In this aspect, the identifying one or more online educational courses is based on a weighted average of the quality measures for each course. The individual quality measures are weighted according to how closely the corresponding difficulty measures match the desired course difficulty measure provided by the user.

In yet a further aspect of the invention, the method also includes, for at least two online educational courses, receiving a content rating of the educational content of the course supplied by the user and other individuals who have reviewed the course. In this aspect, the identifying one or more online educational courses includes collaborative filtering is based on the content ratings.

In another aspect of the invention, the method also includes receiving from the user in the request for the online educational course at least one required course attribute. The required course attribute including at least one of a course subject area, course language, course quality measure, course difficulty measure, course length, course media content, and course author. In this aspect, the identifying one or more online educational courses is based on selecting courses that have attributes that match the required course attributes.

These and other features will become readily apparent from the following detailed description wherein embodiments of the invention are shown and described by way of illustration.

### BRIEF DESCRIPTION OF THE SEVERAL VIEWS OF THE DRAWINGS

For a more complete understanding of various embodiments of the present invention, reference is now made to the following descriptions taken in connection with the accompanying drawings in which:

FIG. 1 illustrates a functional overview of an online learning system.

FIG. 2 illustrates a data flow diagram of the operation of the online learning system.

FIG. 3 is a data set of user numerical quality and difficulty ratings for an online educational course.

FIG. 4 illustrates techniques for creating course profiles.

FIG. 5 illustrates various degrees of interaction between online educational courses and the online learning system.

### DETAILED DESCRIPTION OF THE INVENTION

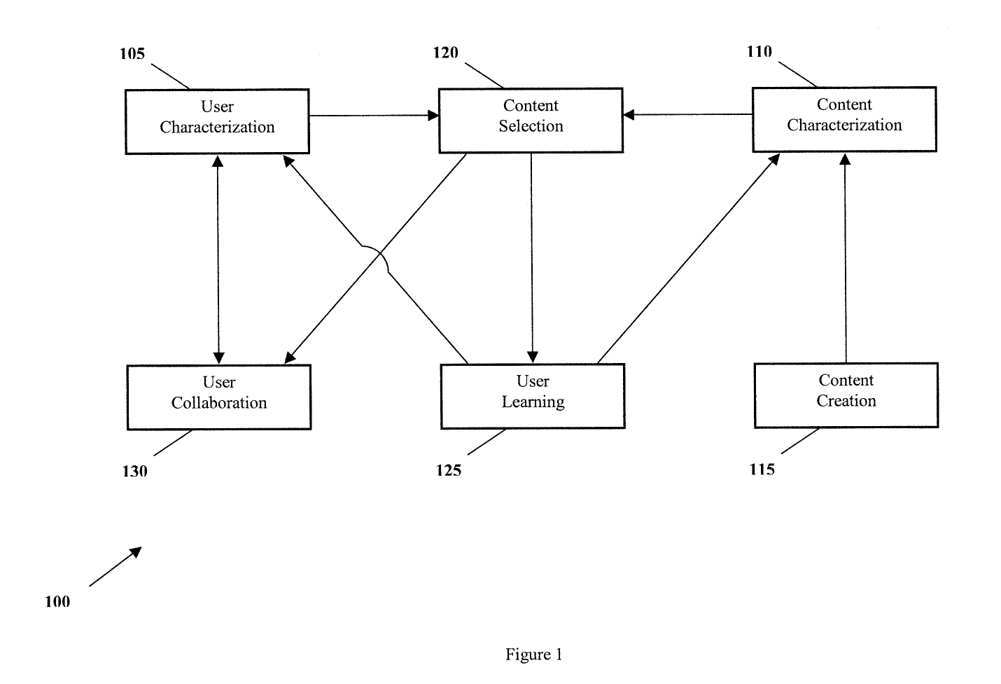

FIG. 1 illustrates the main functional aspects of an online learning system 100 and how these functional aspects interact with each other. System 100 helps a user locate, use, rank, and review online courseware and learning experiences that best match the user's preferences and past experiences. It also tracks the user's learning progress and maintains aspects of the user's learning history, such as completed courses, exam results, and user evaluations. Online learning system 100 characterizes each user that utilizes system 100 (aspect 105). The act of characterizing the user includes collecting information about the user and associating attributes with the user, for example, the user's preferences, abilities, education level, and other information that is relevant when matching the user with a particular educational course. These user attributes are collected and stored in a user profile.

Online learning system 100 also characterizes online educational content (aspect 110). This content characterization includes collecting existing online educational courses and assigning attributes to each course. As described in greater detail below, individuals and automated processes browse the web to identify educational courses and import the content into system 100 or provide to system 100 a website address for the content. In this way, system 100 can host the content directly, provide a portal to the content, or allow the user to link to the content. The attributes assigned to the online educational content provide the means for system 100 to match the user with ideal educational content. These attributes include, for example, general subject area of the content, difficulty, and language of instruction.

Online learning system 100 also provides for the creation of online educational content (aspect 115). Thus, users, teachers, or experts in a particular field create content for direct hosting on system 100. In some implementations of online learning system 100, this is an optional aspect and is omitted.

The attributes associated with the user during the user characterization and the attributes associated with the content during content characterization provide the means for online learning system 100 to select content that best fits the user's preferences and desires (aspect 120). For example, educational content in the targeted subject matter, of the appropriate difficulty and desired depth of treatment, and in the proper language will be selected where the user and content attributes share similar classifications. The techniques and algorithms system 100 uses to match online educational content to the user will be explained in greater detail below.

After online learning system 100 selects and presents the most ideal educational courses to the user, system 100 facilitates the user's educational experience by tracking the user's progress and providing a feedback mechanism to the user (aspect 125). Thus, the user provides evaluations and rankings of educational content both during the learning experience and after a particular course has been completed. These user evaluations modify the attributes associated with the content characterizations, thereby making it easier for subsequent users to locate the most useful material most rapidly. In addition, system 100 modifies the user's profile to reflect the user's experience with the educational content. For example, if the user completes a course, the user's profile will reflect that accomplishment. However, if a user discontinues the course because the course is too advanced for the user's current level of education in the particular subject matter, this aspect of the user's profile is modified.

Online learning system 100 enables the users to collaborate during the learning experience (aspect 130), thereby permitting users to assist each other with the learning process, discuss issues or questions, or generate unique educational content together. In addition, system 100 enables users to work at a common pace and form ad-hoc groups for an entire course, for a particular section of a course, and/or for discussion of a particular idea. System 100 identifies users that share similar attributes in their profiles as potential collaboration members. Similarly, system 100 identifies users that have selected identical online educational content as potential collaboration members. The user collaboration activities in turn are used to modify the users' profiles.

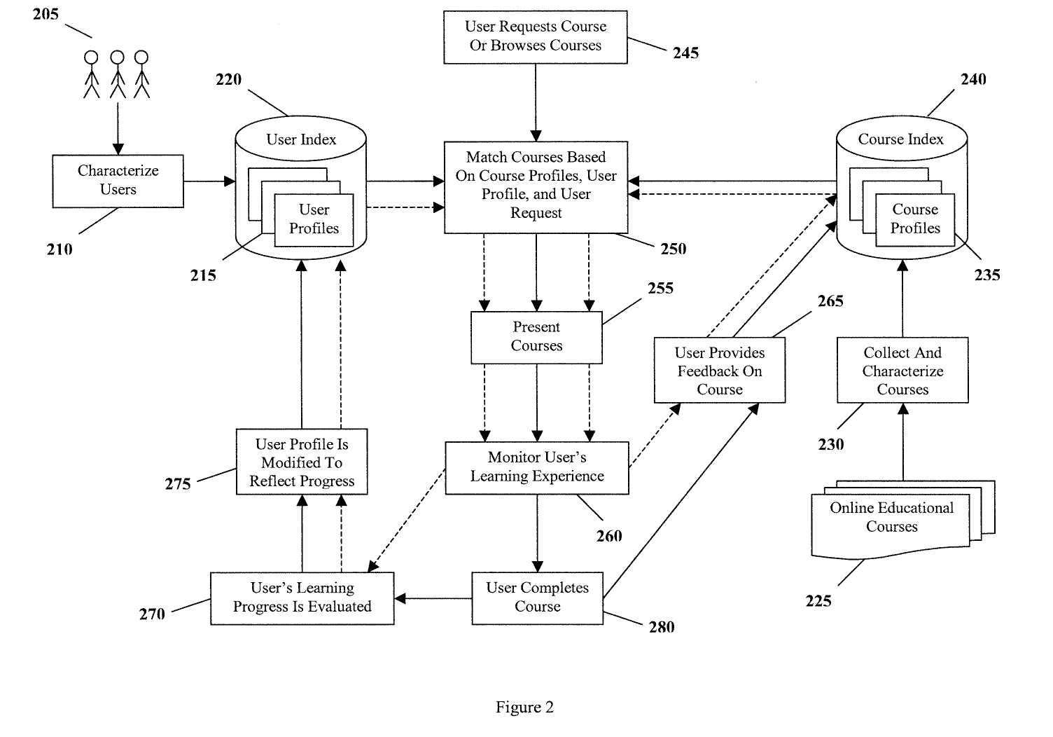

FIG. 2 illustrates a data flow diagram of the operation of online learning system 100. System 100 is capable of operating with multiple users 205, but for the sake of simplicity, some aspects of its operation will be described by referring only to a single user. System 100 characterizes users 205 by identifying various user attributes that are relevant to learning (step 210). These attributes include, for example, languages each user speaks, and each user's language skill level, reading ability, learning preferences, age, gender, level of general education, subject-specific skills, time availability, disabilities, educational interests, work experience, and learning history. This information is solicited from the users through interface screens that present the user with questionnaires or other methods that would reveal user preferences, learning styles, and/or other abilities (for example, diagnostic games can be employed).

System 100 creates and stores a user profile 215 for each user that elects to register with online learning system 100 and retains the user's attributes in their user profile 215. The stored user profiles 215 are cataloged in a user index 220. If the user chooses not to register, system 100 creates a temporary profile of the unregistered user that persists as long as the user's current session lasts by, for example, creating an HTTP cookie on the user's computer. The user can elect to create a profile using the information stored in the HTTP cookie anytime during the then current session.

System 100 also collects the web addresses of and characterizes the content of online educational courses 225 (step 230) to create course profiles 235, which are stored in a course index 240. Each course profile 235 has attributes that characterize the educational content and overall educational experience of each online course. These attributes include, for example, whether the course is taught to a specific exam, whether the course is part of a series of courses, and each course's general subject area, specific subject, overall quality, length, degree of difficulty, depth of treatment, use of media (e.g., sounds, pictures, etc.), languages of instruction, use of tests and/or quizzes, and author.

As described in greater detail below, course collectors search the Internet for online educational courses and create course profiles 235 for each course by analyzing the course content and assigning values to the course attributes mentioned above. Web robot course collectors search the Internet and analyze each course for general subject matter by, e.g., scanning the text of the course descriptions or course materials for keywords associated with broad subject matter topics, such as algebra, biology, chemistry, etc. The web robots also determine apparent course length, media content, and primary language of instruction. Human course collectors review the course materials and assign values to the other course attributes mentioned above and can modify the attributes assigned by the web robots.

When the user makes a request for a course (step 245), online learning system 100 uses the information contained in the user's request (e.g., subject matter keywords), the information in the user's profile 215, and the information in course index 240 to match ideal online courses to the user (step 250). The techniques and algorithms used to select the ideal online courses are discussed in greater detail below. System 100 ranks the matched courses and presents a list of match results to the user (step 255); the results include an abstract of each matched course to assist the user in making the final course selection.

In response to the user's selection of an online course and commencement of learning, system 100 monitors the user's progress throughout the entire course (step 260) by soliciting information from the user about his or her progress or through the use of an e-learning communication standard, as discussed below. As the user advances through the course, the user provides feedback about the content of the course (step 265). This feedback modifies the attributes of course profile 235 of the selected course. These aspects of system 100 are explained in greater detail below.

In response to modification of course profile 235 of the current course, system 100 performs another match of ideal online courses (step 250). If the results of the match indicate that the current course is no longer an ideal match, system 100 informs the user of this fact and presents a revised list of match results to the user (step 255). The user may then elect to discontinue the current course in favor of a different one. For example, if the actual course length is longer than initially indicated in the course's profile 235, a user submits this information to system 100, which modifies course profile 235 of the current course accordingly. System 100 performs another match of ideal online courses (step 250) based on the updated course profile 235. Because the user has indicated in her user profile 215 that she has limited time availability, system 100 ranks shorter courses above the course the user is currently studying and presents the revised list of courses to the user (step 255).

Online learning system 100 also uses the information gathered during the user's learning process to evaluate the user's progress (step 270) and, if necessary, modifies the user's profile 215 to reflect a more accurate characterization of the user (step 275). In response to modification of user profile 215, system 100 performs another match of ideal online courses (step 250). As before, if the results of the match indicate that the current course is no longer an ideal match, system 100 informs the user of this fact and presents a revised list of match results to the user (step 255). The user may then elect to discontinue the current course in favor of a different one.

For example, a user provided information to system 100 that caused it to characterize the user as having a moderate level of skill in the subject of algebra. In response to the user requesting an algebra course, system 100 recommended algebra courses of moderate-high difficulty based on the user's classification of having a moderate skill level. During the first several lessons of a recommended course, the user scores poorly on quizzes provided by the course. Online learning system 100 modifies the user's profile 215 to reflect a low-moderate algebra skill level and performs another match of ideal online courses (step 250) based on the updated user profile 215. Because the user's skill level in the subject matter has been reduced, system 100 recommends algebra courses of moderate difficulty and provides the user with the option of discontinuing his current course and starting a new one.

Upon completing the course (step 280), system 100 evaluates the user's overall progress (step 270) and modifies the user's profile 215 to reflect the user's accomplishment (step 275). If provided by the course and chosen by the user, system 100 also records the grade the user achieved in the user's profile 215. Similarly, the user provides feedback on the completed course (step 265). Because the course is completed at this point, system 100 does not perform another match based on the feedback, but system 100 can recommend a list of possible courses based on the experiences and pathways of previous users. However, course profile 235 is modified as described above, if necessary.

The course profile modification and user profile modification aspects have been described above as separate functions for the sake of simplicity. However, system 100 can modify one or both of the user and/or course profiles in response to the information gathered while monitoring the user's learning progress. In addition, system 100 does not modify course profile 235 solely on the basis of feedback from a single user. Rather, system 100 aggregates feedback from multiple users before modifying the corresponding course profile 235. This provides for more accurate characterization of the course attributes.

Likewise, system 100 uses course feedback provided by other uses to assist in the determination of whether a modification should be made to a particular user's profile 215 or to a particular course's profile 235. For example, a single user may provide feedback indicating that a particular course should be rated as highly difficult. However, because many other users rated the course material as moderately difficult, system 100 determines that the user's profile 215 should be modified to reflect a lower skill level in the subject matter of that course.

As mentioned above, online learning system 100 matches courses to the user (step 250) based on the attributes in the user's profile 215 and the course attributes in the various courses' profiles 235. The user, at least in part, controls which attributes are used for the course match. Thus, the user designates which criteria are important to the user when system 100 is evaluating which courses to recommend. System 100 compares the course's attributes to the user's attributes and the user's expressed preferences and assigns weights to the various criteria to arrive at an overall relative rank of the various courses.

In some situations, system 100 uses the courses' attributes to rank the matched courses relative to one another. In other situations, system 100 requires a given course attribute to have a particular value in order for the particular course to qualify as a potential match.

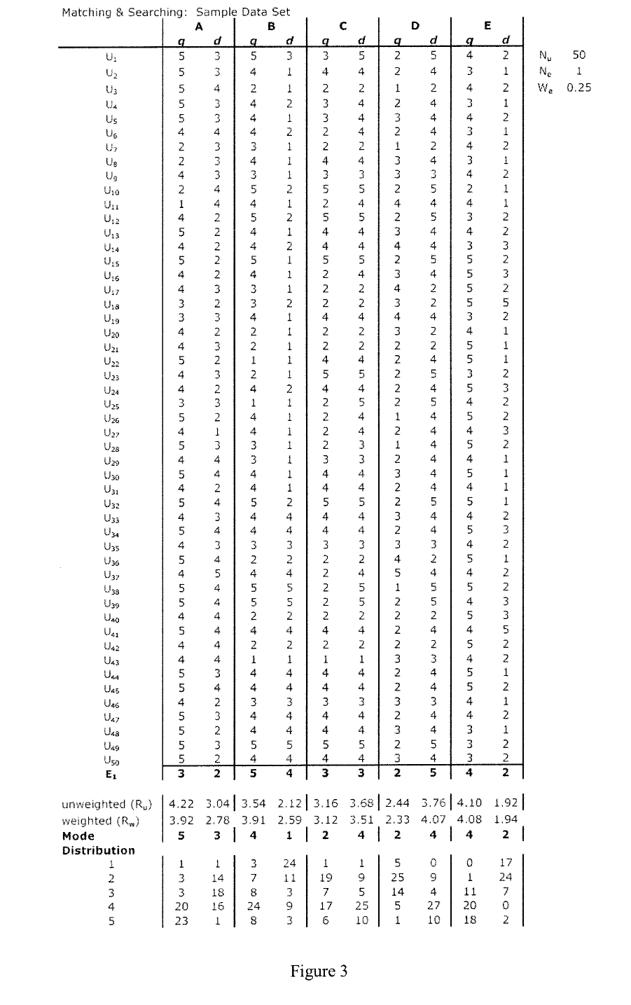

For example, referring to FIG. 3, users U₁ through U₅₀ and expert reviewer E₁ supply a numerical quality rating (q) and numerical difficulty rating (d) of one to five for courses A through E. System 100 uses these course attributes to match a selection of ideal courses with the user. In one scenario, a user is simply searching for the best course among courses A through E. In this case, system 100 assigns a 25% weight to the single expert reviewer rating and a 75% weight to the average of all of the user ratings and calculates the weighted average of the quality rating of each course. System 100 then presents courses A through E to the user ordered according to these weighted average quality ratings, e.g., the courses would be ordered E, A, B, C, D.

In another scenario, a user is searching for a course of medium difficulty (i.e., a course with a difficulty rating of three). In this case, system 100 calculates a weighted average value for overall quality by weighting each of the quality ratings of a particular course according to how closely the corresponding course difficulty rating matches the desired difficulty rating. Thus, system 100 assigns the highest weight to courses that have a difficulty rating that matches what the user desires, while courses with a higher or lower difficulty rating receive a lower weight. For example, this technique calls for assigning a weight factor of three to courses having a difficulty rating of three, a weight factor of two to courses having a difficulty rating of two or four, and a weight factor of one to courses having a difficulty rating of one or five. Equation 1 illustrates this technique for course A.

$${q}_{avg} = \frac{3 \times \sum {q}_{l} + 2 \times \sum {q}_{m} + \sum {q}_{n}}{l + m + n} \qquad Equation 1$$

where
q_{avg}=difficulty weighted average value of quality ratings of course A
l represents the collection of quality ratings for courses having a corresponding course difficulty rating of three for course A
m represents the collection of quality ratings for courses having a corresponding course difficulty rating of two or four for course A
n represents the collection of quality ratings for courses having a corresponding course difficulty rating of one or five for course A

System 100 calculates a difficulty weighted average value of overall quality for each course A through E and presents courses A through E to the user ordered according to these weighted average quality ratings. Thus, the order would be A, B, E, C, D. As described above, system 100 can assign an additional weighting factor to expert reviewer ratings.

In other situations, system 100 requires a given course attribute to have a particular value in order for the particular course to qualify as a potential match. For example, if a user's profile indicates he is only fluent in English and the user designates language of instruction as an attribute to evaluate when recommending a course, online learning system 100 will only present courses that are taught in English. Similarly, if a user's profile indicates that she is hearing-impaired, system 100 will not recommend courses that have audio components.

In yet other situations, the user specifies several acceptable options for attributes for the learning experience he or she is searching for. For example, a user can specify a number of languages of instruction that are acceptable to him, ranked in order of preference, e.g., English first, French second, and Korean third. When searching for ideal courses, system 100 would (1) exclude courses that employ a language of instruction that is not English, French, or Korean and (2) apply ranking weights to the course quality ratings based on the language preferences for the courses taught in English, French, or Korean. For example, Equation 1 is used to determine the weighted average of quality ratings in the same manner as described above by assigning a weighting factor of three to courses taught in English, a weighting factor of two to courses taught in French, and a weighting factor of one to courses taught in Korean.

Online learning system 100 also recommends courses to a particular user by comparing the ranking histories of the user with ranking histories of other users. If a set of users have exhibited similar likes and dislikes with regard to courses the users have taken, system 100 will recommend courses that have received favorable recommendations from some of the users in the set to other users in the set. This is generally known as collaborative filtering. For example, user U₁ has given relatively high ratings to courses T and U, but relatively low ratings to courses V, W, and X. Users U₂, U₃, U₉, and U₁₀ assigned similar ratings to courses T through X. These users also rated course Y very favorably and course Z unfavorably. Therefore, system 100 will recommend course Y to user U₁.

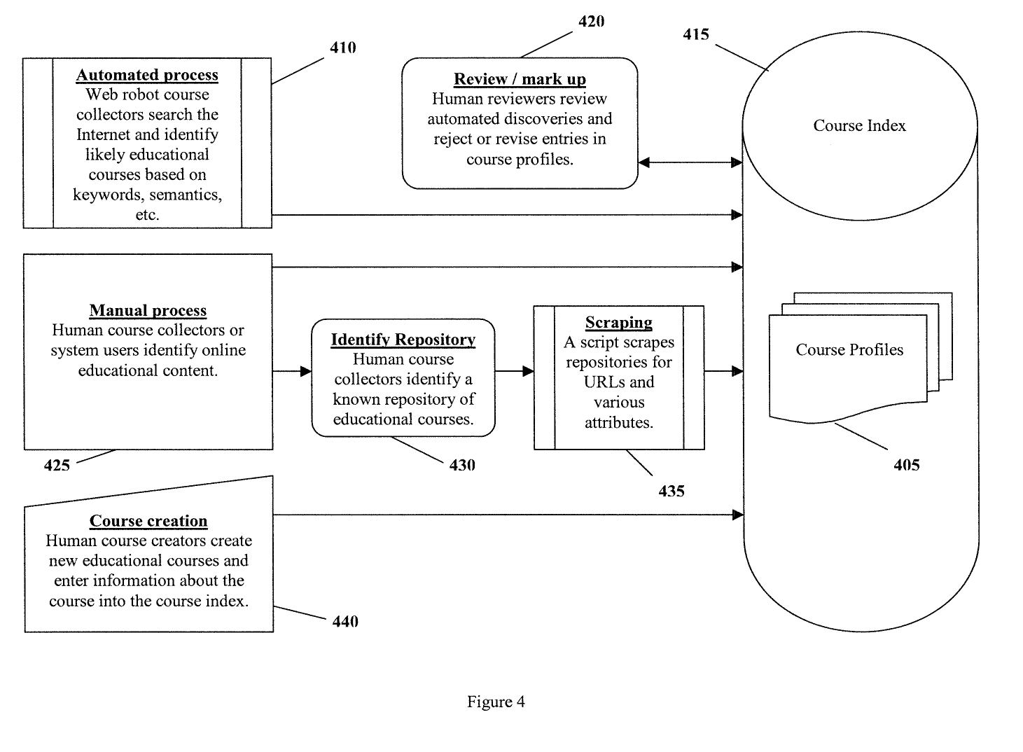

FIG. 4 illustrates techniques used by online learning system 100 for creating course profiles 405 for online educational courses. Automated processes, performed by web robots, search the Internet for educational courses (step 410). Using techniques known in the art, the web robots browse the Internet in a methodical, automated manner and collect information about the various websites that they encounter. The web robots analyze the content of each website; the content includes the rendered information, such as the text and embedded audio and video information, as well as the internal information, such as comments, metadata, scripts, and header information.

The web robots parse the information of each website to identify the presence of keywords or objects that indicate that the website is likely to be an educational course or collection of courses. In most cases, online educational courses and collections thereof are not designated by metadata in a consistent manner. Thus, the web robots will conduct a broad search of the website contents to determine if it qualifies as a potential educational course. As explained in greater detail below, human reviewers then analyze content discovered by the web robots. For example, a particular web robot may parse the body of the website searching for the keywords “course” and “anthropology”. Upon encountering website meeting this criteria, the robot uses basic information about the website, such as its URL, the language of instruction (discovered from a tag in the source code of the webpage), its likely general subject area, and use of media (determined by analyzing links present on the webpage) to create a course profile 405 for the website in course index 415. In addition, if more is know about the structure of a collection of websites, the web robot is programmed to collect content associated with metadata tags included in the website. Expanding on this example, the following illustrative entry would be made in course index 415:
URL: http://ocw.mit.edu/OcwWeb/Anthropology/21A-350JFall-2004/CourseHome/index.htm
Language: <html lang=“en”>
Subject: anthropology
Media Content: none included other than images
Course Description: <meta name=“Description” content=“This course examines computers anthropologically, as meaningful tools revealing . . . ”/>
Author <meta name=“Author” content=“Helmreich, Stefan”/>
Keywords: <meta name=“Keyword” content=“Computing, machines and culture, computation theory, cybernetics . . . ”/>

Human reviewers review both the automated entries in course index 415 and the content of the websites associated with the entries (step 420). If the websites are not educational courses, the reviewers remove the corresponding course profile 405 from course index 415. If the websites are educational courses, the reviewers revise the automated entries as needed and add additional information about the content of the website, for example, the specific subject of the course, the overall quality, the degree of difficulty, depth of treatment, and whether the course is taught to a specific exam.

Using a manual process, human course collectors or users of system 100 also populate course index 415 with course profiles 405 (step 425). In this case, individuals interacting with the system identify new online educational courses, create a new course profile 405, and record information about the course in that profile. In addition, individuals may discover an educational course repository that contains a collection of online educational courses. The individual informs system 100 of the course repository (step 430), and automated targeted web scripts process the webpages of the repository to gather basic information about the various courses of the repository and create new course profiles 405 for each course (step 435), as described above. Human reviewers also review and revise these course profiles 405 as needed (step 420).

Individuals using online learning system 100 also create new online educational content to be hosted by system 100 (step 440). After the new course has been provided to system 100, the creator of the course creates a corresponding course profile 405 and populates it with the attributes of the course. As mentioned above, the course creation functionality is optional in some implementations and can be omitted.

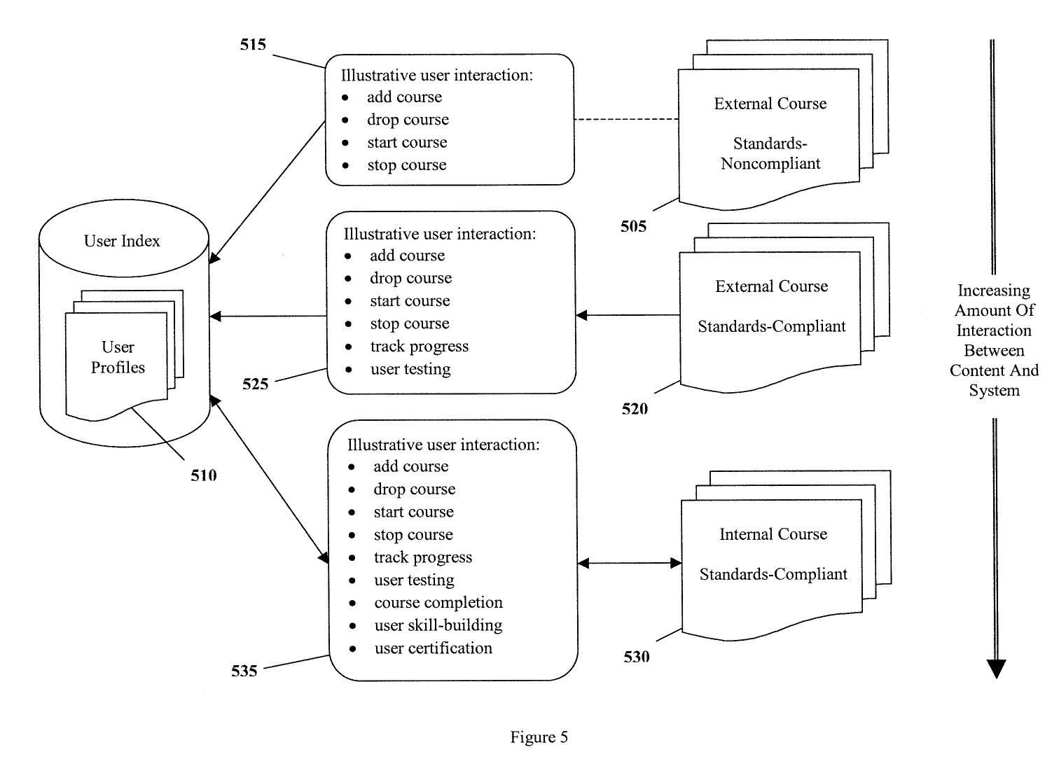

As explained above, online learning system 100 provides educational courses to users gathered from a wide variety of sources. Depending on the content and design of these courses, they are capable of differing levels of interaction with system 100. FIG. 5 illustrates various degrees of interaction between the educational courses and system 100. The illustration differentiates courses on the basis of whether they are external or internal and whether or not they are standards-compliant. Internal courses are hosted by system 100, whereas external course are not. Standards-compliant courses are capable of communicating with a learning management system using a set of standards, such as the SCORM (Sharable Content Object Reference Model) specification of the Advance Distributed Learning Initiative or the various AICC Guidelines and Recommendations of the Aviation Industry CBT Committee. In the SCORM standard, the interaction between a course's metadata and the learning management system is standardized through the SCORM Run-Time Environment (RTE) model. The particular RTE model implementation controls the course's interaction with external or internal standards-compliant learning content (i.e., educational courses). Thus, these standards enable system 100 to track various aspects of the user's learning progress, as described above.

External, standards-noncompliant courses 505 are capable of limited to no interaction between the educational content of the courses and user profiles 510. In some cases, system 100 relies upon the user to report his or her interaction with such content in order to modify the user's profile 510 accordingly. System 100 provides course management webpages to the user that allow him or her to report adding the course, dropping the course, starting the course, and stopping the course (actions 515).

External, standards-compliant courses 520 are capable of more complex interaction with system 100 (actions 525). Although such courses are not hosted by system 100, external, standards-compliant courses 520 are designed to provide information in a predetermined format to systems that are separate from the web servers that are hosting the particular course. Thus, when the user registers for a given course on the web server that hosts the course, the course sends a message in a standard format to system 100 that informs system 100 that the user has registered for the course. Similarly, external, standards-compliant courses 520 inform system 100 when the user drops the course, starts a particular section of the course, and discontinues study. Such a course also informs system 100 of the user's progress and any test scores that the user has received.

With external, standards-compliant courses 520, the course profile system is able to understand the structure and sequence of a given learning object or experience. For example, the Content Aggregation Model (CAM) in the SCORM standard specifies that an XML file reside at the root of a Learning Object. This XML file describes the relationship between the content objects as well as how content is to be delivered to learners, e.g., in what sequence the content objects are to be presented. Thus, rather than simply providing a starting URL to the user, the course profile system organizes the learning experience into “Units”, “Modules”, “Quizzes”, “Projects”, or other subdivisions as intended by the author.

Furthermore, the CAM can designate starting values for variables tracked by the course or user profile system. These variables record the user's progress or status with quizzes or tests. For example, an XML tag “Unit.1.Module.1Quiz.Finish” is initially set to 0 by the CAM, and then set to 1 when the user is successfully accomplishes the interactive quiz for Unit 1. This would pass into the user profile (to indicate knowledge attained) and signify to the learning system the completion of Unit 1 Module 1. Thus, “Completion” for the Learning Object is defined and described in the sequencing and navigation XML within the CAM itself.

Internal, standards-compliant courses 530 are capable of yet further complex interaction with system 100 (actions 535). Because web servers that are part of online learning system 100 host such courses, these courses accept information from system 100 as well as provide information to system 100. Thus, in addition to the interactions described above, these courses are capable of adapting to the user based on feedback from system 100.

For example, a user registers for an internal, standards-compliant physical chemistry course. This course has several subsections, including a subsection on calculus and a subsection on physics that are both applicable to the study of physical chemistry. The physical chemistry course sends a request to system 100 for information about the user's past experience with calculus and physics. System 100 processes the user's profile for this information and sends messages back to the physical chemistry course indicating that the user has a high skill level in calculus and a low skill level in physics. In response to this information, the physical chemistry course modifies its lesson plan to (1) skip the introductory material related to calculus, (2) increase the introductory material related to physics, and (3) include additional quizzes related to physics.

As will be realized, other embodiments are within the following claims. Accordingly, the drawings and description are to be regarded as illustrative in nature and not in a restrictive or limiting sense with the scope of the application being indicated in the claims.

What is claimed is:

1. A computer-implemented method comprising:
identifying a plurality of online educational courses, the online educational courses presenting educational content to a user over time;
creating a course profile for each online educational course, each course profile having one or more attributes of an associated online education course, the attributes characterizing the educational content of the associated online educational course;
receiving attributes of the user, the attributes describing preferences and characteristics of the user;
in response to a request for an online educational course from the user, identifying one or more online educational courses based on the attributes of the user and the attributes of the educational course, wherein the attributes of the user and the attributes of the one or more identified educational courses share a similar classification; and
presenting to the user the identified one or more online educational courses.

2. The method of claim 1, further comprising modifying one or more attributes of the course profiles associated with educational courses based on feedback about the education courses provided by the user.

3. The method of claim 2, wherein the modified course profiles are associated with online educational courses the user has completed.

4. The method of claim 1, further comprising creating a user profile for the user, the user profile having one or more attributes of the associated user, the attributes describing preferences and characteristics of the user.

5. The method of claim 4, further comprising modifying one or more attributes of the user based on the user completing one of the online educational courses.

6. The method of claim 4, further comprising modifying one or more attributes of the user based on progress of the user in one of the online educational courses.

7. The method of claim 1, further comprising:
for at least two online educational courses, receiving a quality measure of the educational content of the course supplied by an individual who has reviewed the course;
wherein identifying one or more online educational courses is based on the quality measures of the at least two courses.

8. The method of claim 1, further comprising:
for at least two online educational courses, receiving at least two quality measures and corresponding difficulty measures of the educational content of the course, said measures supplied by individuals who have reviewed the courses; and
receiving in the request for the online educational course from the user a desired course difficulty measure;
wherein identifying one or more online educational courses is based on a weighted average of the quality measures for each course, the individual quality measures being weighted according to how closely the corresponding difficulty measures match the desired course difficulty measure provided by the user.

9. The method of claim 1, further comprising:
for at least two online educational courses, receiving a content rating of the educational content of the course supplied by the user and other individuals who have reviewed the course;
wherein identifying one or more online educational courses includes collaborative filtering based on the content ratings.

10. The method of claim 1, further comprising:
receiving from the user in the request for the online educational course at least one required course attribute, the required course attribute including at least one of a course subject area, course language, course quality measure, course difficulty measure, course length, course media content, and course author;
wherein identifying one or more online educational courses is based on selecting courses having attributes matching the required course attributes.

11. A system comprising:
a computer system;
a user interface;
program code on a computer-readable medium, which when executed on the computer system performs functions including:
identifying a plurality of online educational courses, the online educational courses presenting educational content to a user over time;
creating a course profile for each online educational course, each course profile having one or more attributes of an associated online education course, the attributes characterizing the educational content of the associated online educational course;
receiving attributes of the user, the attributes describing preferences and characteristics of the user;
in response to a request for an online educational course from the user, identifying one or more online educational courses based on the attributes of the user and the attributes of the educational course, wherein the attributes of the user and the attributes of the one or more identified educational courses share a similar classification; and
presenting to the user through the user interface the identified one or more online educational courses.

12. The method of claim 11, the program code when executed on the computer system further performs the functions of modifying one or more attributes of the course profiles associated with educational courses based on feedback about the education courses provided by the user.

13. The method of claim 12, wherein the modified course profiles are associated with online educational courses the user has completed.

14. The method of claim 11, the program code when executed on the computer system further performs the functions of creating a user profile for the user, the user profile having one or more attributes of the associated user, the attributes describing preferences and characteristics of the user.

15. The method of claim 14, the program code when executed on the computer system further performs the functions of modifying one or more attributes of the user based on the user completing one of the online educational courses.

16. The method of claim 14, the program code when executed on the computer system further performs the functions of modifying one or more attributes of the user based on progress of the user in one of the online educational courses.

17. The method of claim 11, the program code when executed on the computer system further performs the functions of:
for at least two online educational courses, receiving a quality measure of the educational content of the course supplied by an individual who has reviewed the course;
wherein identifying one or more online educational courses is based on the quality measures of the at least two courses.

18. The method of claim 11, the program code when executed on the computer system further performs the functions of:
for at least two online educational courses, receiving at least two quality measures and corresponding difficulty measures of the educational content of the course, said measures supplied by individuals who have reviewed the courses; and
receiving in the request for the online educational course from the user a desired course difficulty measure;
wherein identifying one or more online educational courses is based on a weighted average of the quality measures for each course, the individual quality measures being weighted according to how closely the corresponding difficulty measures match the desired course difficulty measure provided by the user.

19. The method of claim 11, the program code when executed on the computer system further performs the functions of:
for at least two online educational courses, receiving a content rating of the educational content of the course supplied by the user and other individuals who have reviewed the course;
wherein identifying one or more online educational courses includes collaborative filtering based on the content ratings.

20. The method of claim 11, the program code when executed on the computer system further performs the functions of:
receiving from the user in the request for the online educational course at least one required course attribute, the required course attribute including at least one of a course subject area, course language, course quality measure, course difficulty measure, course length, course media content, and course author;
wherein identifying one or more online educational courses is based on selecting courses having attributes matching the required course attributes.
